(19) United States
(12) Patent Application Publication
(10) Pub. No.: US 2024/0330039 A1
(43) Pub. Date: Oct. 3, 2024

(54) CONTROLLING READ AND WRITE OPERATIONS OF INTER-INTEGRATED CIRCUITS

(71) Applicant: Black Sesame Technologies (Shenzhen) Co., Ltd., Shenzhen (CN)

(72) Inventors: Zhili Zou, Shenzhen (CN); Bintian Zhou, Shanghai (CN)

(21) Appl. No.: 18/617,583

(22) Filed: Mar. 26, 2024

(30) Foreign Application Priority Data
Mar. 28, 2023 (CN) 2023103716741

(51) Int. Cl. G06F 9/48; G06F 9/30

(52) U.S. Cl. CPC G06F 9/485; G06F 9/30145; G06F 9/4812

(57) ABSTRACT

A System on a Chip (SoC), a processor and an instruction processing method are provided. The SoC includes a processor, an Inter-Integrated Circuit (I2C) read and write device and an I2C controller, wherein the processor is configured to: write a target instruction to the I2C read and write device; and stop writing the target instruction to the I2C read and write device and performing another task in response to detecting that a number of times that the target instruction has not been successfully written to the I2C read and write device consecutively reaches N, where N>=2; the I2C read and write device is configured to parse the target instruction, and generate and output an I2C instruction corresponding to the target instruction; and the I2C controller is configured to perform a control operation on a connected slave device based on the I2C instruction. Instruction execution efficiency and performance of the processor may be improved.

### CROSS-REFERENCE TO RELATED APPLICATION

This application claims the benefit under 35 U.S.C. § 119 (a) of the filing date of Chinese Patent Application No. 202310371674.1, filed in the Chinese Patent Office on Mar. 28, 2023. The disclosure of the foregoing application is herein incorporated by reference in its entirety.

### TECHNICAL FIELD

The present disclosure relates to an Inter-Integrated Circuit (I2C) technology field, and more particularly, to a System on a Chip (SoC), a processor and an instruction processing method.

### BACKGROUND

I2C is a bidirectional binary synchronous serial bus and is widely used in daily life.

In an autonomous driving field, multiple image sensors are installed on a vehicle to sense surrounding environment. A configuration interface of each image sensor is an I2C interface from which a processor obtains data acquired by the image sensor (the image sensor serves as a slave device).

In existing techniques, when the processor reads and writes the slave device, instruction execution efficiency is relatively low, and performance is relatively poor.

### SUMMARY

Embodiments of the present disclosure may improve instruction execution efficiency and performance of a processor.

In an embodiment of the present disclosure, an SoC is provided, including a processor, an I2C read and write device and an I2C controller, wherein the processor is configured to: write a target instruction to the I2C read and write device; and stop writing the target instruction to the I2C read and write device and performing another task in response to detecting that a number of times that the target instruction has not been successfully written to the I2C read and write device consecutively reaches N, where N>=2: the I2C read and write device is configured to parse the target instruction, and generate and output an I2C instruction corresponding to the target instruction; and the I2C controller is configured to perform a control operation on a connected slave device based on the I2C instruction.

Optionally, the I2C read and write device includes an instruction receiving register, an instruction cache First-In-First-Out (FIFO) module, an instruction fetching control module and an instruction decoding module, wherein the instruction receiving register is configured to receive the target instruction; the instruction cache FIFO module is configured to output the target instruction to the instruction fetching control module; the instruction fetching control module is configured to cache the target instruction; and the instruction decoding module is configured to decode the target instruction, and generate and output the I2C instruction corresponding to the target instruction.

Optionally, the processor is configured to: obtain an operation state of the instruction receiving register; write the target instruction to the instruction receiving register in response to detecting that the instruction receiving register is in an idle state; and stop writing the target instruction to the instruction receiving register, in response to detecting that the instruction receiving register is in a busy state and that a number of times that the instruction receiving register is in the busy state consecutively reaches N.

Optionally, the processor is configured to consecutively write to the instruction receiving register at least two target instructions that meet a preset condition; and the I2C read and write device is further configured to merge the at least two target instructions that meet the preset condition.

Optionally, the preset condition includes any one of the following: register addresses pointed by the at least two target instructions being adjacent: or a difference between the register addresses pointed by the at least two target instructions having a predetermined distance.

Optionally, the SoC further includes a data cache configured to cache data returned by the slave device.

Optionally, the SoC further includes an interrupt signal merging module configured to merge interrupt signals generated by the I2C read and write device and the I2C controller to obtain a merged signal, and output the merged signal to the processor.

Optionally, the target instruction includes at least one of the following: a register data field of the slave device, a register address field of the slave device, an identity field of the slave device, a data address format field of the slave device, an I2C read and write direction field, or an access mode field.

In an embodiment of the present disclosure, an instruction processing method is provided, including: obtaining a number of times that a target instruction has not been successfully written to an I2C read and write device consecutively: stopping writing the target instruction to the I2C read and write device and performing another task in response to detecting that the number of times that the target instruction has not been successfully written to the I2C read and write device consecutively reaches N, where N>=2; and rewriting the target instruction to the I2C read and write device in response to receiving an interrupt signal output by the I2C read and write device.

Optionally, the instruction processing method further includes: consecutively writing to the I2C read and write device at least two target instructions that meet a preset condition, wherein the preset condition includes any one of the following: register addresses pointed by the at least two target instructions being adjacent; or a difference between the register addresses pointed by the at least two target instructions having a predetermined distance.

Optionally, the instruction processing method further includes: reading data returned for M times by a slave device in response to detecting that a number of times that the data is returned by the slave device reaches a preset number M, wherein M>=2.

In an embodiment of the present disclosure, a processor is provided, including: an acquiring circuitry configured to obtain a number of times that a target instruction has not been successfully written to an I2C read and write device consecutively; and a performing circuitry configured to: stop writing the target instruction to the I2C read and write device and perform another task in response to detecting that the number of times that the target instruction has not been successfully written to the I2C read and write device consecutively reaches N; and rewrite the target instruction to the I2C read and write device in response to receiving an interrupt signal output by the I2C read and write device.

Embodiments of the present disclosure may provide following advantages.

The processor stops writing the target instruction to the I2C read and write device and performs another task in response to detecting that the number of times that the target instruction has not been successfully written to the I2C read and write device consecutively reaches N. As a result, the processor does not need to continue waiting for a response from the I2C read and write device, thereby effectively improving instruction execution efficiency and performance of the processor.

Further, the target instruction may carry at least one of a register data field of the slave device, a register address field of the slave device, an identity field of the slave device, a data address format field of the slave device, an I2C read and write direction field, or an access mode field, which enables one target instruction to carry various types of information without a need to generate a target instruction corresponding to each type of information, thereby further effectively improving the instruction execution efficiency and performance of the processor.

Further, the processor consecutively transmits at least two target instructions that meet the preset condition, and the I2C read and write device merges the at least two target instructions into one instruction for execution, which further improves the instruction execution efficiency and performance of the processor.

Further, the processor reads the data returned by the slave device from the data cache in response to detecting that the number of times that the data is stored into the data cache reaches a predetermined number. Therefore, it is unnecessary to read the returned data every time the slave device returns the data, which further improves the instruction execution efficiency and performance of the processor.

### BRIEF DESCRIPTION OF THE DRAWINGS

FIG. 1 is a structural diagram of an SoC according to an embodiment;

FIG. 2 is a flow chart of an instruction processing method according to an embodiment; and

FIG. 3 is a flow chart of a data reading method according to an embodiment.

### DETAILED DESCRIPTION

In the exiting techniques, during a process of reading and writing a slave device, in response to failing to successfully write an instruction to an I2C read and write device, the processor may query a state of the I2C read and write device until the instruction is successfully written. During the process, the processor does not process other tasks, resulting in low instruction execution efficiency and poor performance of the processor.

In embodiments of the present disclosure, a processor stops writing a target instruction to an I2C read and write device and performs another task in response to detecting that a number of times that the target instruction has not been successfully written to the I2C read and write device consecutively reaches N. As a result, the processor does not need to continue waiting for a response from the I2C read and write device, thereby effectively improving instruction execution efficiency and performance of the processor.

In order to clarify the objects, characteristics and advantages of the disclosure, embodiments of present disclosure will be described in detail in conjunction with accompanying drawings.

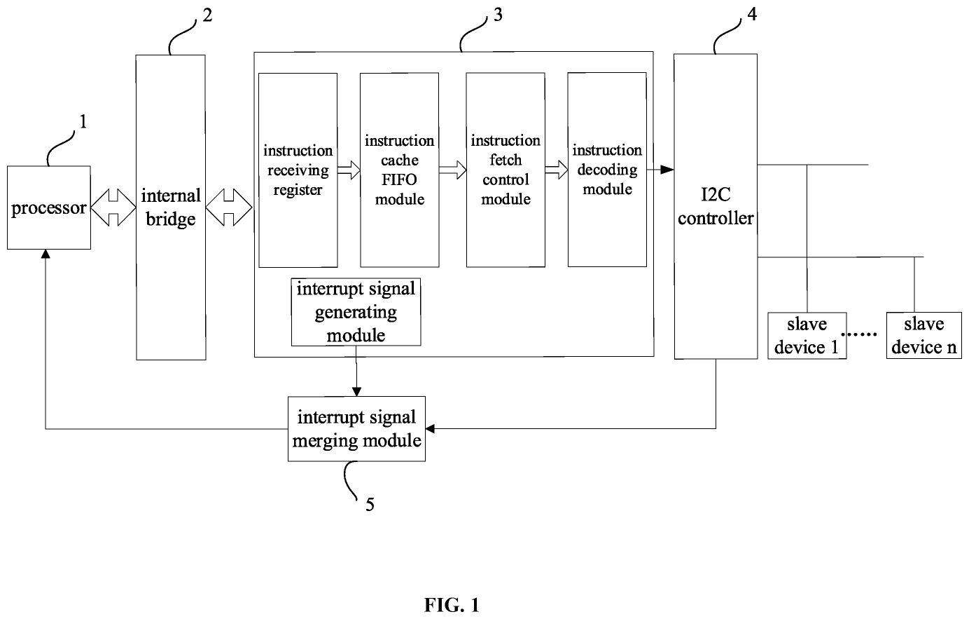

FIG. 1 is a structural diagram of an SoC according to an embodiment.

In some embodiments, the SoC may include a processor 1, an I2C read and write device 3, and an I2C controller 4.

In some embodiments, the I2C read and write device 3 may include an instruction receiving register, an instruction cache FIFO module, an instruction fetch control module, and an instruction decoding module.

In some embodiments, the processor 1 communicates with the I2C read and write device 3 through an internal bus and an internal bridge 2. The processor 1 may include a Microcontroller (MCU), a Central Processing Unit (CPU) or other devices with a processing function.

During an operation process, the processor 1 generates a target instruction and writes the generated target instruction into the instruction receiving register. The After receiving the target instruction, the instruction receiving register transmits the target instruction to the instruction cache FIFO module. The instruction cache FIFO module outputs the target instruction to the instruction fetch control module in a FIFO order. The instruction decoding module reads the target instruction from the instruction fetch control module, decodes the target instruction to obtain information carried in the target instruction, and generates and outputs a corresponding I2C instruction to the I2C controller 4. The I2C controller 4 controls a slave device to perform a corresponding operation based on the received I2C instruction. The I2C controller 4 may control n slave devices. FIG. 1 merely illustrates a slave device 1 and a slave device n which represent n slave devices.

In some embodiments, the target instruction generated by the processor 1 may have a specific instruction format. That is, in some embodiments, the instruction format of the target instruction generated by the processor 1 may be different from that of an instruction generated by a processor in the exiting techniques.

In some embodiments, the target instruction may include multiple domains. Specifically, the target instruction may include at least one of a register data field of the slave device, a register address field of the slave device, an identity field of the slave device, a data address format field of the slave device, an I2C read and write direction field, or an access mode field.

The register data field of the slave device is used to carry data of a register of the slave device. The register address field of the slave device is used to carry an address of the register of the slave device. The identity field of the slave device is used to carry an identity of the slave device (such as an ID of the slave device). The data address format field of the slave device is used to carry bit width of the address of the register of the slave device and bit width of the data of the register of the slave device. The I2C read and write direction field is used to indicate an I2C read and write direction. The access mode field is used to indicate a mode of quick access.

In some embodiments, if a value of the I2C read and write direction field is configured as a first value, it indicates to perform a writing operation of I2C data; or if the value of the I2C read and write direction field is configured as a second value, it indicates to perform a reading operation of the I2C data.

Length of the I2C read and write direction field may be 1 bit. If the value of the I2C read and write direction field is configured as 1, it indicates to perform a reading operation of the I2C data: or if the value of the I2C read and write direction field is configured as 0, it indicates to perform a writing operation of the I2C data.

In some embodiments, if the target instruction includes the access mode field, it indicates that the target instruction is configured with a fast access mode. Accordingly, the target instruction does not need to be delivered to the instruction cache FIFO module, but is directly transmitted to the instruction decoding module.

In some embodiments, in order of bits from low to high, distribution of bit fields in the target instruction may be as follows: the register data field of the slave device, the register address field of the slave device, the identity field of the slave device, the data address format field of the slave device, the I2C read and write direction field and the access mode field.

In some embodiments, the target instruction may include at least two of the above six fields. As one target instruction can carry multiple fields each of which carries specific information, one target instruction can be used to transmit various types of information. In other words, when various types of information need to be sent, the processor 1 merely needs to transmit one target instruction. However, in the existing techniques, one instruction can merely carry one type of information (that is, one of the six fields mentioned above), and thus when multiple types of information need to be sent, the processor needs to transmit multiple instructions.

From above, compared with the existing techniques, solutions in the embodiments of the present disclosure may improve integration of instructions (that is, one target instruction carries various types of information), thereby effectively improving the instruction execution efficiency of the processor 1.

In some embodiments, the target instruction includes the above-mentioned 6 fields occupying a total of 44 bits which includes following content:
[15:0], which represents the register data field of the slave device and is 16 bits in length, where if the address data format field of the slave device sets the data to be in an 8-bit format, valid data occupies lower 8 bits:
[31:16], which represents the register address field of the slave device and is 16 bits in length, where if the address data format field of the slave device sets the address to be in an 8-bit format, a valid address occupies lower 8 bits:
[39:32], which represents the identity field of the slave device and is 8 bits in length, where if the identity (ID number) of the slave device is merely 7 bits, the identity of the slave device may be shifted to the left by 1 bit, for example, the identity of the slave device is 0x33, and after shifting 1 bit to the left, the identity of the slave device is 0x6a:
[41:40], which represents the address data format field of the slave device and is 2 bits in length, where if its value is 00, it indicates that the address occupies 8 bits and the data occupies 8 bits: if its value is 01, it indicates that the address occupies 8 bits and the data occupies 16 bits; if its value is 10, it indicates that the address occupies 16 bits and the data occupies 8 bits; or if its value is 11, it indicates that the address occupies 16 bits and the data occupies 16 bits.
[42:42], which represents the I2C read and write direction and is 1 bit in length, where if its value is 0, it represents writing: or if its value is 1, it represents reading; and
[43:43], which indicates whether a fast mode is configured and is 1 bit in length, where if its value is 1, it indicates that the fast mode is configured: or if its value is 0, it indicates that a normal mode is configured.

Those skilled in the art could understand that the distribution of the 44 bits in the above target instruction only be exemplary description. In specific applications, the number, types and bit length of fields included in the target instruction may be set according to actual application requirements, which is not described in detail in the embodiments of the present disclosure.

In some embodiments, after receiving the target instruction, the processor 1 may first query whether the instruction receiving register is in an idle state. In response to detecting that the instruction receiving register is in an idle state, the processor 1 writes the target instruction to the instruction receiving register through the internal bus and the internal bridge 2. In response to detecting that the instruction receiving register is in a busy state, the processor 1 continues to query an operation state of the instruction receiving register. In response to detecting that the instruction receiving register is in the busy state consecutively for N times, the processor 1 may stop querying the operation state of the instruction receiving register and perform other operations. After receiving an interrupt signal output by the instruction cache FIFO module, the processor 1 writes the target instruction into the instruction receiving register.

In some embodiments, N>=2. For the sake of higher operation efficiency of the processor 1, N=2.

In some embodiments, the instruction cache FIFO module may include a FIFO module and an interrupt signal generating module. The FIFO module is configured to store an instruction queue which waits to be read and decoded by the instruction decoding module. The interrupt signal generating module is configured to monitor an empty/full state of the instruction queue. If a number of instructions stored in the FIFO module is smaller than a predetermined value, the interrupt signal generating module may generate and transmit an interrupt signal to the processor 1. After receiving the interrupt signal, the processor 1 continues to write the target instruction to the instruction receiving register.

In summary, in response to detecting that the instruction receiving register is in the busy state consecutively for N times, the processor 1 may stop querying the operation state of the instruction receiving register and perform other operations. The instruction cache FIFO module is a hardware structure that processes the instruction queue when the processor 1 performs other operations. After completing the operation on a portion of instructions, the instruction cache FIFO module notifies the processor 1 to transmit the target instruction.

From above, in response to detecting that the instruction receiving register is in the busy state consecutively for N times, the processor 1 stops querying the operation state of the instruction receiving register and performs other operations. Therefore, a querying time of the processor 1 may be effectively reduced, and execution efficiency of the processor 1 may be improved.

In some embodiments, the instruction fetch control module may serve as a cache to cache the stored target instruction. After fetching the target instruction, the instruction decoding module decodes the target instruction.

The instruction decoding module may include a decoding control state machine and an I2C instruction generator.

Specifically, the decoding control state machine in the instruction decoding module may obtain the target instruction, and the I2C instruction generator converts information carried in each field of the target instruction into a corresponding I2C instruction. The I2C instruction may include START instruction, STOP instruction, ADDRESS instruction, ACK instructions, etc., thereby driving the I2C controller 4 to complete I2C transmission.

In some embodiments, the decoding control state machine may merge multiple adjacent target instructions, and one target instruction corresponds to one I2C transmission. In other words, the instruction decoding module merges the multiple adjacent target instructions to realize merging multiple I2C transmission cycles into one transmission cycle, which greatly saves time.

In some embodiments, if two target instructions have a same transmission direction, and have a same writing time in the instruction queue of a same slave device, the two target instructions are considered to be adjacent. Two target instructions having the same transmission direction means that the two target instructions being merged in a write direction, or the two target instructions being merged in a read direction.

For example, write configuration is required for two register addresses 0x5 and 0x6 of a same slave device. A value of bit [23:16] of the target instruction corresponding to one register 0x5 is 0x5, and a value of bit [23:16] of the target instruction corresponding to another register 0x6 is 0x6. The target instruction corresponding to the register 0x5 is first written into a FIFO module. Immediately afterwards, the target instruction corresponding to the register 0x6 is also written into the FIFO module. The two target instructions are written to the FIFO module at adjacent times. During a decoding stage, the above two target instructions may be merged to generate an I2C transmission instruction.

For the write direction, for example, two register addresses including 0x5 and 0x6 of a slave device need to be written, and register data is one byte.

Existing solutions require two I2C write operations including a first write operation to the register 0x5 and a second write operation to the register 0x6. A specific transmission process is as follows (a handshake ACK response procedure is ignored here).

The first write operation includes: transmitting a START instruction→transmitting a slave device address→transmitting a write instruction→transmitting a slave device register address 0x5→transmitting register 0x5 data of the slave device→transmitting a STOP instruction.

The second write operation includes: transmitting a START instruction-≥transmitting a slave device address→transmitting a write instruction→transmitting a slave device register address 0x6→transmitting register 0x6 data of the slave device→transmitting a STOP instruction.

However, in the embodiments of the present disclosure, two write operations are merged into one write operation. A specific transmission process is as follows (a handshake ACK response procedure is ignored here).

The write operation includes: transmitting a START instruction→transmitting a slave device address→transmitting a write instruction→transmitting a slave device register address 0x5→transmitting register 0x5 data of the slave device→transmitting register 0x6 data of the slave device→transmitting a STOP instruction.

For the read direction, for example, two register addresses including 0x5 and 0x6 of a slave device need to be read, and register data is one byte.

Existing solutions require two I2C read operations including a first read operation to the register 0x5 and a second read operation to the register 0x6. A specific transmission process is as follows (a handshake ACK response procedure is ignored here).

The first read operation includes: transmitting a START instruction→transmitting a slave device address→transmitting a write instruction→transmitting a slave device register address 0x5→transmitting a STOP instruction→transmitting a slave device address→transmitting a read instruction→receiving register 0x5 data of the slave device→transmitting a STOP instruction.

The second read operation includes: transmitting a START instruction→transmitting a slave device address→transmitting a write instruction→transmitting a slave device register address 0x6→transmitting a STOP instruction→transmitting a slave device address→transmitting a read instruction→receiving register 0x6 data of the slave device→transmitting a STOP instruction.

However, in the embodiments of the present disclosure, two read operations are merged into one read operation. A specific transmission process is as follows (a handshake ACK response procedure is ignored here).

The read operation includes: transmitting a START instruction→transmitting a slave device address→transmitting a write instruction→transmitting a slave device register address 0x5→transmitting a STOP instruction→transmitting a slave device address→transmitting a read instruction→receiving register 0x5 data of the slave device→receiving register 0x6 data of the slave device→transmitting a STOP instruction.

From above, by merging the adjacent target instructions, the time and process of I2C instruction processing may be effectively saved, and processing efficiency of I2C instructions may be improved.

In some embodiments, the I2C controller 4 may include a transmission control state machine, a Serial Clock Line (SCL) transmitter, a Serial Data (SDA) transmitter, an SDA receiver, and an interrupt signal generator.

In some embodiments, the transmission control state machine may generate an I2C interface transmission timing to control each transmission stage of I2C. The SCL transmitter generates an SCL clock, the SDA transmitter transmits SDA data, the SDA receiver receives the SDA data, and the interrupt signal generator monitors a handshake with the slave device. If handshake information ACK with the slave device is incorrect, the interrupt signal generator generates an interrupt signal and notifies the processor 1. The interrupt signal generator also monitors a data return situation of the slave device. If data return is completed, the interrupt signal generator may also generate an interrupt signal and notify the processor 1.

In some embodiments, the I2C controller 4 may be connected with multiple slave devices via an I2C bus. In an autonomous driving field, slave devices may be perception sensors, such as image sensors, displacement sensors, or distance sensors.

It could be understood that a specific structure, implementation principles, and an operation process of the I2C controller 4 may be referred to the existing techniques, and are not described in detail in the embodiments of the present disclosure.

In some embodiments, the SoC may further include a data cache (not shown in FIG. 1). The data cache is configured to cache data returned by the slave device. Specifically, the data cache may cache multiple data. After receiving the data returned by the slave device, the I2C controller 4 notifies the processor 1 through an interrupt signal, and the data returned by the slave device is stored in the data cache. The processor 1 may record a number of interrupt signals received. In response to the number of the data cached in the data cache reaches a certain value, the processor 1 reads the cached data from the data cache to realize centralized reading of multiple data at one time. Compared with performing one read operation for one returned data, reading multiple returned data together may improve execution efficiency of the processor 1.

In some embodiments, the SoC may further include an interrupt signal merging module 5 configured to merge the generated interrupt signals.

In some embodiments, the SoC may further include an internal memory.

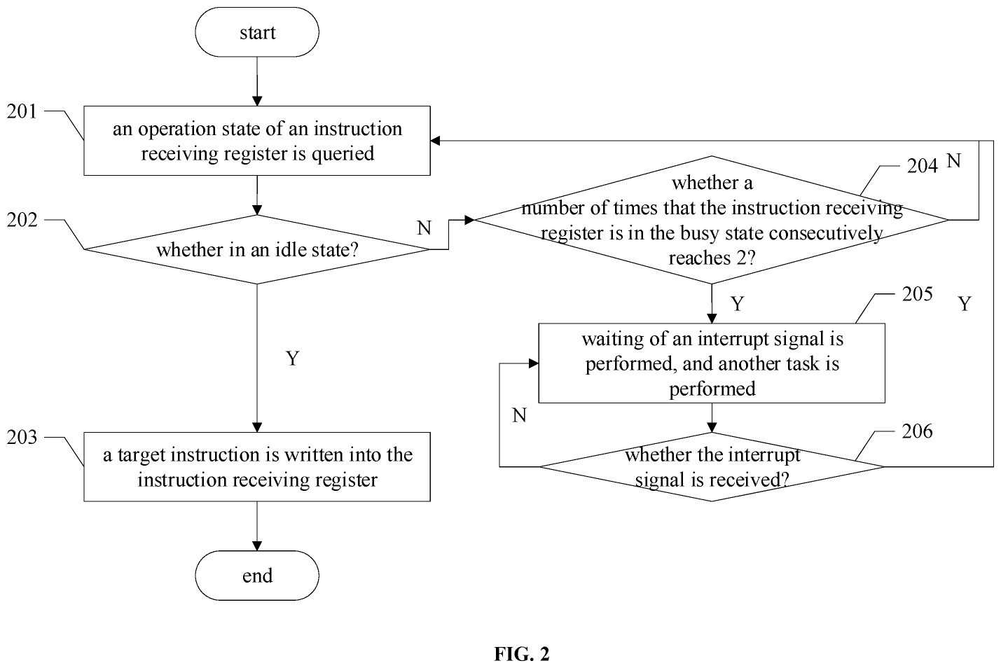

Referring to FIG. 2, an instruction processing method is provided according to an embodiment, which is described in detail below through specific steps.

In some embodiments, the instruction processing method may be performed by the processor in the SoC described in the above embodiments. Instructions corresponding to the instruction processing method may be the target instructions described in the above embodiments.

In 201, an operation state of an instruction receiving register is queried.

In 202, it is determined whether the instruction receiving register is in an idle state.

In some embodiments, if the instruction receiving register is in the idle state, 203 is performed: or if the instruction receiving register is in a busy state, 204 is performed.

In 203, a target instruction is written into the instruction receiving register.

In 204, it is determined whether a number of times that the instruction receiving register is in the busy state consecutively reaches 2.

If the processor learns that the number of times that the instruction receiving register is in the busy state consecutively has not reached 2, 201 is performed again: or if the processor learns that the number of times that the instruction receiving register is in the busy state consecutively has reached 2, 205 is performed.

In 205, waiting of an interrupt signal is performed, and another task is performed.

In some embodiments, the processor may wait for an interrupt signal generated by an instruction cache FIFO module.

In 206, it is determined whether the interrupt signal is received.

In some embodiments, if the processor receives the interrupt signal, 201 is performed again: otherwise, the processor continues to perform 205 to continue to wait for the interrupt signal.

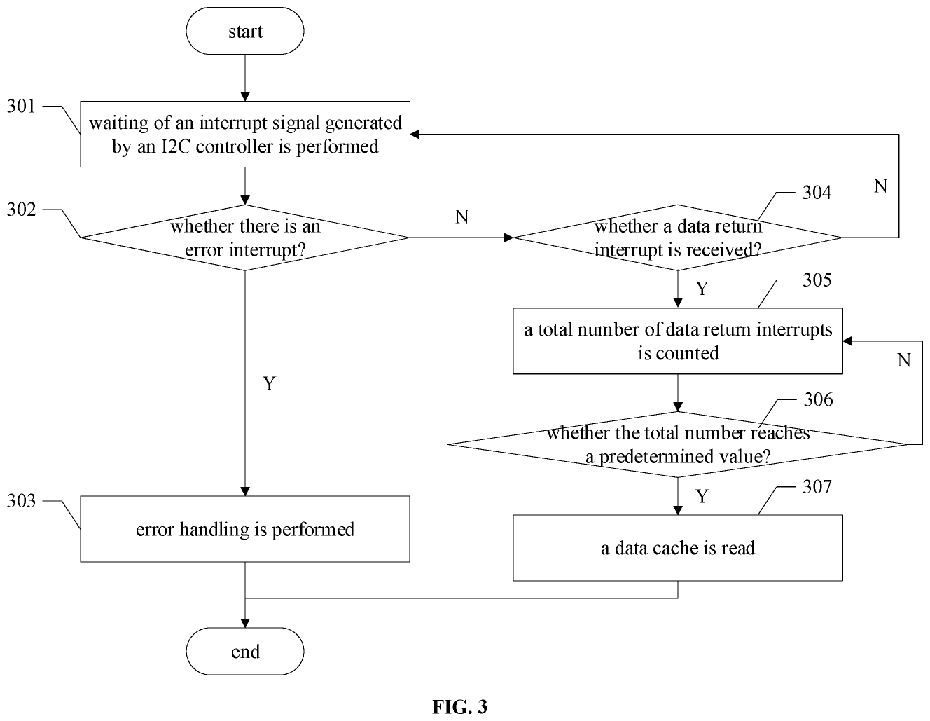

Referring to FIG. 3, a data reading method is provided according to an embodiment, which is described in detail below through specific steps.

In some embodiments, the data reading method may be performed by the processor in the SoC described in the above embodiments.

In 301, waiting of an interrupt signal generated by an I2C controller is performed.

In 302, it is determined whether there is an error interrupt.

In some embodiments, if there is an error interrupt, 303 is performed; or if there is no error interrupt, 304 is performed.

In 303, error handling is performed.

In some embodiments, when an error interrupt exists, error handing related to the error interrupt may be performed.

In 304, it is determined whether a data return interrupt is received.

In some embodiments, if a data return interrupt is received, 305 is performed: or if a data return interrupt is not received, 301 is continued.

In 305, a total number of data return interrupts is counted.

In some embodiments, the processor may count the total number of the data return interrupts received.

In 306, it is determined whether the total number reaches a predetermined value.

In some embodiments, if the total number of the data return interrupts received reaches the predetermined value, the processor performs 307; otherwise, the processor performs 301 again.

In 307, a data cache is read.

Therefore, the processor is capable of reading multiple returned data at one time.

In an embodiment, a processor is provided, including an acquiring circuitry and a performing circuitry. The acquiring circuitry is configured to obtain a number of times that a target instruction has not been successfully written to an I2C read and write device consecutively. The performing circuitry is configured to: stop writing the target instruction to the I2C read and write device and perform another task in response to detecting that the number of times that the target instruction has not been successfully written to the I2C read and write device consecutively reaches N; and rewrite the target instruction to the I2C read and write device in response to receiving an interrupt signal output by the I2C read and write device.

A specific execution process of the above-mentioned processor may be referred to the above-mentioned embodiments, and is not described in detail here.

Those skilled in the art could understand that all or part of steps in the various methods in the above embodiments can be completed by instructing relevant hardware through a program, and the program can be stored in any computer-readable storage medium which includes a ROM, a RAM, a magnetic disk or a compact disc.

Although the present disclosure has been disclosed above with reference to preferred embodiments thereof, it should be understood that the disclosure is presented by way of example only, and not limitation. Those skilled in the art can modify and vary the embodiments without departing from the spirit and scope of the present disclosure.

What is claimed is:

1. A System on a Chip (SoC), comprising a processor, an Inter-Integrated Circuit (I2C) read and write device and an I2C controller,
wherein the processor is configured to: write a target instruction to the I2C read and write device; and stop writing the target instruction to the I2C read and write device and performing another task in response to detecting that a number of times that the target instruction has not been successfully written to the I2C read and write device consecutively reaches N times, where N>=2;
wherein the I2C read and write device is configured to parse the target instruction, and generate and output an I2C instruction corresponding to the target instruction; and
wherein the I2C controller is configured to perform a control operation on a connected slave device based on the I2C instruction.

2. The SoC according to claim 1, wherein the I2C read and write device comprises an instruction receiving register, an instruction cache First-In-First-Out (FIFO) module, an instruction fetching control module, and an instruction decoding module,
wherein the instruction receiving register is configured to receive the target instruction;
wherein the instruction cache FIFO module is configured to output the target instruction to the instruction fetching control module;
wherein the instruction fetching control module is configured to cache the target instruction; and
wherein the instruction decoding module is configured to decode the target instruction, and generate and output the I2C instruction corresponding to the target instruction.

3. The SoC according to claim 2, wherein the processor is configured to:
obtain an operation state of the instruction receiving register;
write the target instruction to the instruction receiving register in response to detecting that the instruction receiving register is in an idle state; and
stop writing the target instruction to the instruction receiving register, in response to detecting that the instruction receiving register is in a busy state and that a number of times that the instruction receiving register is in the busy state consecutively reaches N times.

4. The SoC according to claim 2, wherein the processor is configured to consecutively write to the instruction receiving register at least two target instructions that meet a preset condition; and
wherein the I2C read and write device is further configured to merge the at least two target instructions that meet the preset condition.

5. The SoC according to claim 4, wherein the preset condition comprises any one of the following:
register addresses pointed by the at least two target instructions being adjacent; or
a difference between the register addresses pointed by the at least two target instructions reaching a predetermined distance.

6. The SoC according to claim 1, further comprising a data cache configured to cache data returned by the slave device.

7. The SoC according to claim 1, further comprising an interrupt signal merging module configured to merge interrupt signals generated by the I2C read and write device and the I2C controller to obtain a merged signal, and output the merged signal to the processor.

8. The SoC according to claim 1, wherein the target instruction comprises at least one of the following:
a register data field of the slave device, a register address field of the slave device, an identity field of the slave device, a data address format field of the slave device, an I2C read and write direction field, or an access mode field.

9. An instruction processing method, comprising:
obtaining a number of times that a target instruction has not been successfully written to an Inter-Integrated Circuit (I2C) read and write device consecutively;
stopping writing the target instruction to the I2C read and write device and performing another task in response to detecting that the number of times that the target instruction has not been successfully written to the I2C read and write device consecutively reaches N times, where N>=2; and
rewriting the target instruction to the I2C read and write device in response to receiving an interrupt signal output by the I2C read and write device.

10. The instruction processing method according to claim 9, further comprising: consecutively writing to the I2C read and write device at least two target instructions that meet a preset condition, wherein the preset condition comprises any one of the following: register addresses pointed by the at least two target instructions being adjacent; or a difference between the register addresses pointed by the at least two target instructions reaching a predetermined distance.

11. The instruction processing method according to claim 9, further comprising:
reading data returned for M times by a slave device in response to detecting that a number of times that the data is returned by the slave device reaches a preset number M, wherein M>=2.

12. A processor, comprising:
an acquiring circuitry configured to obtain a number of times that a target instruction has not been successfully written to an Inter-Integrated Circuit (I2C) read and write device consecutively; and
a performing circuitry configured to: stop writing the target instruction to the I2C read and write device and perform another task in response to detecting that the number of times that the target instruction has not been successfully written to the I2C read and write device consecutively reaches N times; and rewrite the target instruction to the I2C read and write device in response to receiving an interrupt signal output by the I2C read and write device.

13. The processor according to claim 12, wherein the I2C read and write device is configured to parse the target instruction, and generate and output an I2C instruction corresponding to the target instruction.

14. The processor according to claim 13, wherein the I2C instruction is transmitted to an I2C controller configured to perform a control operation on a connected slave device based on the I2C instruction.

15. The processor according to claim 13, wherein the I2C read and write device comprises an instruction receiving register, an instruction cache First-In-First-Out (FIFO) module, an instruction fetching control module, and an instruction decoding module,
wherein the instruction receiving register is configured to receive the target instruction;
wherein the instruction cache FIFO module is configured to output the target instruction to the instruction fetching control module;
wherein the instruction fetching control module is configured to cache the target instruction; and
wherein the instruction decoding module is configured to decode the target instruction, and generate and output the I2C instruction corresponding to the target instruction.

16. The processor according to claim 15, wherein the processor is configured to:
obtain an operation state of the instruction receiving register;
write the target instruction to the instruction receiving register in response to detecting that the instruction receiving register is in an idle state; and
stop writing the target instruction to the instruction receiving register, in response to detecting that the instruction receiving register is in a busy state and that a number of times that the instruction receiving register is in the busy state consecutively reaches N times.

17. The processor according to claim 15, wherein the processor is configured to consecutively write to the instruction receiving register at least two target instructions that meet a preset condition; and
wherein the I2C read and write device is further configured to merge the at least two target instructions that meet the preset condition.

18. The processor according to claim 17, wherein the preset condition comprises any one of the following:
register addresses pointed by the at least two target instructions being adjacent; or
a difference between the register addresses pointed by the at least two target instructions reaching a predetermined distance.

19. The processor according to claim 12, wherein the target instruction comprises at least one of the following:
a register data field of a slave device, a register address field of a slave device, an identity field of a slave device, a data address format field of a slave device, an I2C read and write direction field, or an access mode field.

20. The processor according to claim 12, wherein the processor is configured to receive a merged signal transmitted from an interrupt signal merging module, wherein the interrupt signal merging module is configured to merge interrupt signals generated by the I2C read and write device
